(19) United States
(12) Patent Application Publication
(10) Pub. No.: US 2018/0202213 A1
(43) Pub. Date: Jul. 19, 2018

(54) OPENING AND CLOSING CONTROL DEVICE

(71) Applicant: KABUSHIKI KAISHA TOKAI RIKA DENKI SEISAKUSHO, Aichi (JP)

(72) Inventor: Shuji SHITARA, Aichi (JP)

(73) Assignee: KABUSHIKI KAISHA TOKAI RIKA DENKI SEISAKUSHO, Aichi (JP)

(21) Appl. No.: 15/743,374

(22) PCT Filed: Jul. 20, 2016
(86) PCT No.: PCT/JP2016/071325

§ 371 Date: Jan. 10, 2018

(30) Foreign Application Priority Data
Jul. 22, 2015 (JP) 2015-145055

(51) Int. Cl. E05F 15/46; E05F 15/41; B60J 1/16

(52) U.S. Cl. CPC E05F 15/46; E05F 15/603; B60J 1/16; E05F 15/41

(57) ABSTRACT

An opening/closing control device controls movement of an opening/closing body. The opening/closing control device includes an entrapment detection sensor configured to perform entrapment detection in a closing movement of the opening/closing body, a pulse generator configured to generate pulses in accordance with a movement speed of the opening/closing body, and a control unit configured to determine that the opening/closing body has reached a fully-closed position when the entrapment detection sensor detects entrapment after the pulses generated by the pulse generator indicates that movement of the opening/closing body has stopped.

### TECHNICAL FIELD

The present invention relates to an opening/closing control device that controls movement of an opening/closing body.

### BACKGROUND ART

Patent document 1 discloses a power window system that functions to prevent entrapment as one example of an opening/closing control device. In such type of a power window system, when an operation switch receives an operation input, an opening or closing movement of a door window is performed. That is, the opening movement that lowers (down) the door window is performed when a user performs an opening operation on the operation switch, and the closing movement that lifts (up) the door window is performed when the user performs a closing operation on the operation switch.

The opening operation and the closing operation each include a manual operation that stops movement of the door window when an operation performed by the user is canceled and an automatic operation that continues the movement of the door window until the door window reaches a fully-open position or a fully-closed position even when the operation performed by the user is canceled. The manual operation includes a manual down operation for instructing the lowering movement and a manual up operation for instructing the lifting movement. The automatic operation includes an automatic down operation for instructing the lowering movement and an automatic up operation for instructing the lifting movement. For example, when the automatic up operation is performed, the lifting movement of the door window is continued until the door window reaches the fully-closed position.

The power window system usually acknowledges the position of the door window by setting the fully-closed position as a reference. A detected zone where the entrapment prevention function is active and a non-detected zone where the entrapment prevention function is inactive are set between the fully-open position and the fully-closed position of the door window.

Thus, when the automatic up operation is performed on the operation switch and entrapment is detected by an entrapment detection sensor in the detected zone of the door window, the occurrence of an entrapment is determined. This reverses movement of the door window and releases an entrapment subject from the door window. When the automatic up operation is performed on the operation switch and entrapment is detected by the entrapment detection sensor in the non-detected zone of the door window, the door window is determined to have reached the fully-closed position. This stops the movement of the door window.

### PRIOR ART DOCUMENT

### Patent Document

Patent Document 1: Japanese Laid-Open Patent Publication No. 2005-314949

### SUMMARY OF THE INVENTION

### Problems that are to be Solved by the Invention

The position of the window is unknown immediately after the door is assembled or the battery is exchanged. Thus, the detected zone and the non-detected zone of the door window cannot be set. Accordingly, if the automatic up operation is performed on the operation switch immediately after the power is turned on, the occurrence of entrapment is determined at the fully-closed position. This reverses the door window. That is, the automatic up operation cannot be performed immediately after the power is turned on. In order to enable the automatic up operation immediately after the power is turned on, the entrapment prevention function has to be disabled.

Thus, the manual up operation and an initialization task need to be performed with the operation switch immediately after the power is turned on to detect the fully-closed position of the door window. The initialization task and the manual up operation need to be performed on each door and require time to perform the manual up operation and time to check the fully-closed position of the door window. This lowers the working efficiency.

It is an object of the present invention to provide an opening/closing control device that improves the working efficiency of the initialization task for detecting the fully-closed position.

### Means for Solving the Problem

One aspect of the present invention is an opening/closing control device that controls movement of an opening/closing body. The opening/closing control device includes an entrapment detection sensor configured to perform entrapment detection in a closing movement of the opening/closing body, a pulse generator configured to generate pulses in accordance with a movement speed of the opening/closing body, and a control unit configured to determine that the opening/closing body has reached a fully-closed position when the entrapment detection sensor detects entrapment after the pulses generated by the pulse generator indicates that movement of the opening/closing body has stopped.

In this configuration, when the opening/closing body reaches the fully-closed position, pulses generated from the pulse generator detect that the opening/closing body has stopped, and an affirmative detection performed by the entrapment detection sensor detects that the opening/closing body is fully closed. The defining of the order of the detections avoids situations in which the fully-closed position is determined as entrapment. That is, when the automatic operation that continues the movement of the door window until the door window reaches the fully-open position is performed by combining the entrapment detection sensor and the pulse output means, the fully-closed position is automatically detected. This completes the initialization task. Thus, the automatic operation can be performed immediately after the power is turned on.

In the automatic operation, once the first operation input instructs movement of the opening/closing body, the movement of the opening/closing body is automatically detected. This is different from the manual operation that stops movement of the door window when an operation is canceled. Thus, when performing the initialization task with the automatic operation, a worker does not need to continue an operation input until the opening/closing body reaches the fully-closed position. Thus, the working time and burden are reduced. This improves the working efficiency of the initialization task for detecting the fully-closed position.

### Effect of the Invention

The present invention improves the working efficiency of the initialization task for detecting the fully-closed position.

### BRIEF DESCRIPTION OF THE DRAWINGS

FIG. 1 is a schematic diagram showing the configuration of a power window system immediately after a window glass is coupled to a door.

FIG. 2 is a table showing lifting operation determinations made immediately after the coupling.

### EMBODIMENTS OF THE INVENTION

One embodiment of an opening/closing control device will now be described.

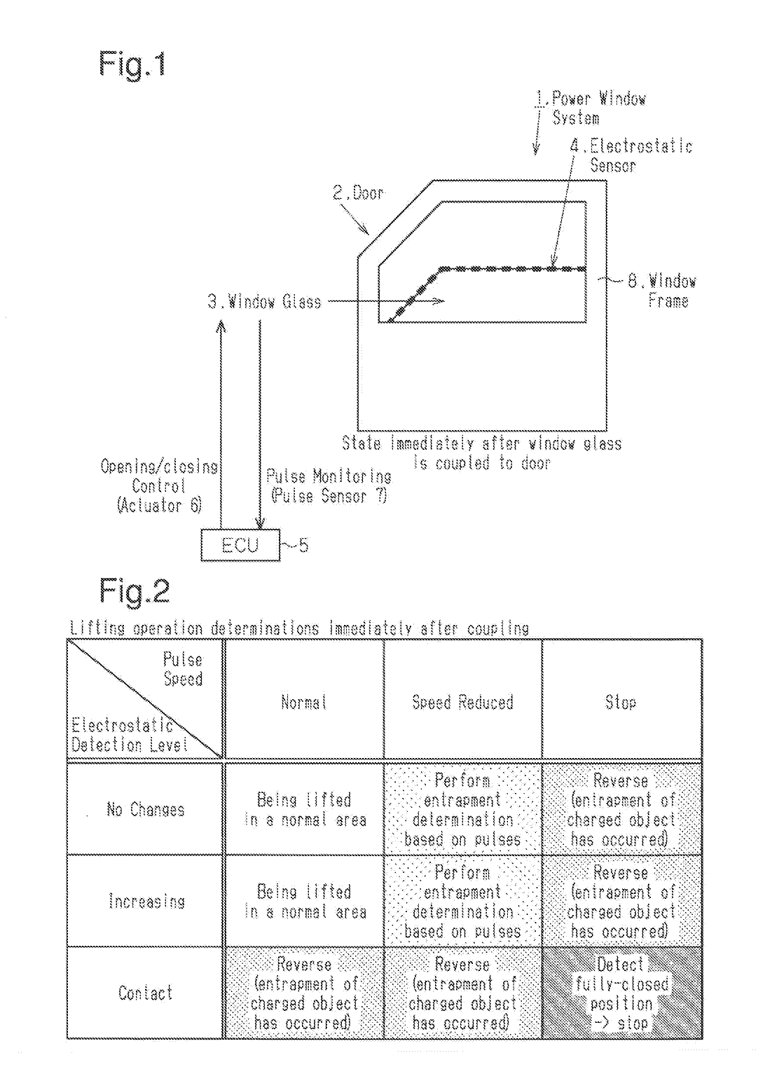

As shown in FIG. 1, a power window system 1, which is one example of the opening/closing control device, controls the opening and closing movements of a window glass 3 that is arranged in a door 2 of a vehicle. The opening movement of the window glass 3 is defined by a lowering movement of the window glass 3, and the closing movement of the window glass 3 is defined by a lifting movement of the window glass 3. The window glass 3 corresponds to an opening/closing body. The window glass 3 slides in a window frame. When the window glass 3 is lifted, the window glass 3 slides in a glass run near an upper end of the glass 3 as it reaches the fully-closed position. An electrostatic sensor 4, which is one example of an entrapment detection sensor, is arranged on an upper end surface of the window glass 3. The electrostatic sensor 4 detects changes in the capacitance of a detected subject. The electrostatic sensor 4 detects entrapment when the capacitance becomes greater than or equal to a threshold value (affirmative detection). In such a case, the electrostatic sensor 4 can detect the approach of a charged object, in addition to contact of a charged object, depending on the setting of the threshold value. The electrostatic sensor 4 does not detect entrapment when the capacitance is less than the threshold value (negative detection).

The power window system 1 includes an electronic control unit (ECU) 5 that centrally controls the opening and closing movements of the window glass 3 and an operation switch (not shown) that receives an operation input for starting the opening or closing movement of the window glass 3. The operation switch is arranged, for example, near a seat. When the operation switch receives an operation input, the ECU 5 centrally controls the opening or closing movement of the window glass 3 through an actuator 6 in accordance with the operation input. The lowering movement of the window glass 3 is performed based on a down operation (one example of opening operation), and the lifting movement of the window glass 3 is performed based on an up operation (one example of closing operation). The down operation includes a manual down operation and an automatic down operation. The up operation includes a manual up operation and an automatic up operation.

The actuator 6 includes a DC motor that produces rotation in forward and reverse directions. A pulse sensor 7 is incorporated in the DC motor. The pulse sensor 7 generates pulses synchronized with rotation of an output shaft. That is, the pulse sensor 7 generates pulses in accordance with a movement speed of the window glass 3. The pulse sensor 7 corresponds to a pulse generator. The ECU 5 monitors the pulses generated by the pulse sensor 7 and the capacitance detected by the electrostatic sensor 4 to change the opening or closing movement of the window glass 3 in accordance with the monitoring result. For example, when the automatic up operation is performed on the operation switch and the ECU 5 determines that entrapment has occurred during the lifting of the window glass 3, the ECU 5 reverses the movement of the window glass 3. This releases an entrapment subject from the window glass 3. The ECU 5 corresponds to a control means.

The operation of the power window system 1 will now be described.

The position of the window glass 3 is unknown immediately after the window glass 3 is coupled to the door 2 (refer to FIG. 1). In this state, the fully-closed position has not yet been detected. Thus, a detected zone and a non-detected zone cannot be set.

Accordingly, an initialization task for detecting the fully-closed position is necessary in the prior art. In the present example, an initialization task is executed when an automatic up operation is performed immediately after the coupling. The ECU 5 monitors a pulse speed of the pulse sensor 7 related to a movement speed of the window glass 3 and a detection level of capacitance detected by the electrostatic sensor 4 to perform various determinations in accordance with the monitoring result (refer to FIG. 2).

As shown in FIG. 2, if the pulse speed is a normal speed when the detection level of the capacitance has not changed or the detection level of the capacitance has increased within a range less than a threshold value, this would indicate that the lifting movement of the window glass 3 is being performed without any problems. Thus, the ECU 5 determines that the window glass 3 is being lifted in a normal area.

If the pulse speed is the normal speed when the detection level of the capacitance reaches a threshold value that indicates contact, the ECU 5 determines that entrapment of a charged object has occurred and reverses movement of the window glass 3. That is, when a charged object contacts the electrostatic sensor 4, the ECU 5 reverses movement of the window glass 3. In this case, the ECU 5 lowers the window glass 3 until the window glass 3 reaches the fully-open position or over a predetermined time. When the window glass 3 is lowered and the pulse speed indicates that the movement of the window glass 3 has stopped, the ECU 5 determines that the window glass 3 has reached the fully-open position and stops the movement of the window glass 3.

Further, if the pulse speed indicates that the movement of the window glass 3 has reduced speed when the detection level of the capacitance has not changed or the detection level of the capacitance has increased within a range less than the threshold value, it can be understood that such effects result from the window glass 3 sliding in the glass run. Thus, the ECU 5 determines entrapment based only on pulses. In this case, the ECU 5 detects entrapment when a physical quantity based on the pulses of the pulse sensor 7 becomes greater than or equal to a reversing threshold value. In the entrapment determination based on pulses, a first-time limited reversing threshold value is set exceeding the physical quantity based on the pulses of the pulse sensor 7 when assuming that the window glass 3 is sliding in the glass run. The first-time limited reversing threshold value is greater than the reversing threshold value set under the assumption that the window glass 3 is sliding outside the glass run. The first-time limited reversing threshold value is only used for the first lifting movement immediately after the power is turned on.

As described above, the first-time limited reversing threshold value is used only for the first lifting movement immediately after the power is turned on. Alternatively, during the first lifting movement after the power is turned on, the first-time limited reversing threshold value may be used if the pulse speed indicates that the movement of the window glass 3 has reduced speed when the detection level of the capacitance increases within a range less than the threshold value. This means that the use of the first-time limited reversing threshold value is limited to when sliding of the window glass 3 in the glass run is detected during the first lifting movement after the power is turned on.

If the pulse speed indicates that the movement of the window glass 3 has reduced speed when the detection level of the capacitance reaches the threshold value indicating contact, the ECU 5 determines that entrapment of a charged object has occurred in the glass run and reverses the movement of the window glass 3. The ECU 5 lowers the window glass 3 until the window glass 3 reaches the fully-open position or over the predetermined time.

In addition, if the pulse speed indicates that the movement of the window glass 3 has stopped when the detection level of the capacitance does not change or the detection level of the capacitance increases within a range less than the threshold value, the ECU 5 determines that entrapment of a non-charged object has occurred in the glass run and reverses the movement of the window glass 3. The ECU 5 lowers the window glass 3 until the window glass 3 reaches the fully-open position or over the predetermined time.

When the capacitance detection level reaches the threshold value indicating contact after the pulse speed indicates that the movement of the window glass 3 has stopped, the ECU 5 determines that the window glass 3 has reached the fully-closed position and stops the movement of the window glass 3. This completes the initialization task for detecting the fully-closed position. The completion of the initialization task allows the position of the window glass 3 at the fully-closed position to be acknowledged as a reference. This enables position-related parameters (for example, detected zone and non-detected zone).

As described above, the present embodiment has the advantages described below.

(1) The initialization task for detecting the fully-closed position is completed by the first automatic up operation performed after the power is turned on (refer to bottom line of right column in FIG. 2). This eliminates the need for a worker to continue an operation input until the window glass 3 reaches the fully-closed position. Thus, the working time and burden are reduced. This improves the working efficiency of the initialization task for detecting the fully-closed position.

(2) When the electrostatic sensor 4 affirmatively detects entrapment before the pulses generated by the pulse sensor 7 indicate that the movement of the window glass 3 has stopped, the ECU 5 determines that entrapment has occurred (refer to bottom line of left column and bottom line of center column in FIG. 2). In this configuration, the entrapment can be distinguished from the fully-closed position before and after detecting that the movement of the window glass 3 has stopped.

(3) When pulses generated by the pulse sensor 7 indicate that the movement of the window glass 3 has reduced speed and the electrostatic sensor 4 negatively detects entrapment, the ECU 5 performs an entrapment determination based on pulses (refer to top line of center column and middle line of center column in FIG. 2). In this configuration, when the movement of the window glass 3 reduces speed, entrapment may have occurred. In this case, an entrapment determination can be performed based on pulses instead of the entrapment determination performed with the electrostatic sensor 4. This configuration allows for detection of whether or not entrapment has occurred.

(4) When the electrostatic sensor 4 affirmatively detects entrapment before pulses generated by the pulse sensor 7 indicate that movement of the window glass 3 has stopped, the ECU 5 determines that entrapment of a charged object has occurred (refer to bottom line of left column and bottom line of center column in FIG. 2). This configuration allows for detection of whether or not a charged object has been entrapped.

(5) If pulses generated by the pulse sensor 7 indicate that movement of the window glass 3 has stopped when the electrostatic sensor 4 negatively detects entrapment, the ECU 5 determines that entrapment of a non-charged object has occurred (refer to top line of right column and middle line of right column in FIG. 2). This configuration can detect whether or not a non-charged object is entrapped.

(6) During the first lifting movement after the power is turned on, the ECU 5 uses the first-time limited reversing threshold value to perform an entrapment determination based on pulses (refer to top line of center column and middle line of center column in FIG. 2). This configuration avoids situations in which the entrapment determination with the pulse affirmatively detects entrapment when the window glass 3 slides in the glass run during the first lifting movement after the power is turned on. That is, erroneous reversal of the window glass 3 can be canceled.

(7) In relation to (6), during the first lifting movement after the power is turned on, when pulses generated by the pulse sensor 7 indicate that the movement of the window glass 3 has reduced speed and the electrostatic sensor 4 detects capacitance that has an increasing tendency at a level less than the threshold value, the ECU 5 may use the first-time limited reversing threshold value to determine entrapment with the pulses (refer to middle line of center column in FIG. 2). This configuration avoids situations in which the entrapment determination with the pulse affirmatively detects entrapment when the window glass 3 slides in the glass run during the first lifting movement after the power is turned on. In addition, this configuration further ensures detection of actual entrapment when using a reversing threshold value that is smaller than the first-time limited reversing threshold value when the window glass 3 slides outside the glass run.

(8) The automatic up operation is applicable while keeping the entrapment prevention function enabled immediately after the power is turned on.

The above embodiment may be modified as described below.

The present invention may be applied to an opening/closing control device that controls an opening/closing body such as a shutter of a building in which an opening movement is defined by a lifting operation and a closing movement is defined by a lowering operation.

The present invention may be applied to an opening/closing control device that controls an opening/closing body that moves in the horizontal direction, for example, a sliding door of a vehicle or an automatic door of a building.

The present invention may be applied to an opening/closing control device that controls a sunroof or the like of a vehicle.

In the entrapment determination based on pulses, the physical quantity based on pulses generated by the pulse sensor 7 may be defined as follows. Whenever the ECU 5 receives pulses from the pulse sensor 7, the ECU 5 calculates an average pulse cycle T (AVE) by adding the latest pulse cycle T(0), which was last received, and all previous pulse cycles T(1) to T(N−1), which were received 1 to N−1 cycles before the latest pulse, and then dividing the sum by N. Further, the ECU 5 calculates a cycle differential value ΔT(0) by subtracting the average pulse cycle T (AVE) from the latest pulse cycle T(0). The cycle differential value ΔT(0) may be set as the physical quantity.

1. An opening/closing control device that controls movement of an opening/closing body, the opening/closing control device comprising:
an entrapment detection sensor configured to perform entrapment detection during a closing movement of the opening/closing body;
a pulse generator configured to generate pulses in accordance with a movement speed of the opening/closing body; and
a control unit configured to determine that the opening/closing body has reached a fully-closed position when the entrapment detection sensor detects entrapment after the pulses generated by the pulse generator indicate that movement of the opening/closing body has stopped.

2. The opening/closing control device according to claim 1, wherein the control unit is configured to determine that entrapment has occurred when the entrapment detection sensor detects entrapment before the pulses indicate that movement of the opening/closing body has stopped.

3. The opening/closing control device according to claim 1, wherein
the control unit is configured to perform an entrapment determination based on the pulses if the pulses indicate that movement of the opening/closing body has reduced speed when the entrapment detection sensor does not detect entrapment, and
the entrapment determination based on the pulses includes detecting entrapment when a physical quantity based on the pulses becomes greater than or equal to a reversing threshold value.

4. The opening/closing control device according to claim 1, wherein
the entrapment detection sensor is an electrostatic sensor that detects entrapment when capacitance, which is electric charge accumulated in a detected subject, becomes greater than or equal to a threshold value, and
the control unit is configured to determine that entrapment of a charged object has occurred when the electrostatic sensor detects entrapment before the pulses indicate that movement of the opening/closing body has stopped.

5. The opening/closing control device according to claim 4, wherein the control unit is configured to determine that entrapment of a non-charged object has occurred if the pulses do not indicate that movement of the opening/closing body has stopped when the electrostatic sensor detects entrapment.

6. The opening/closing control device according to claim 1, wherein
the opening/closing body is a window glass configured to slide in a window frame and reach the fully-closed position by sliding in a glass run of the window frame,
the control unit is configured to perform entrapment determinations based on the pulses if the pulses indicate that movement of the window glass has reduced speed when the entrapment detection sensor does not detect entrapment,
the entrapment determinations based on the pulses include detecting entrapment when a physical quantity based on the pulses becomes greater than or equal to a reversing threshold value,
the control unit is configured to perform the entrapment determinations based on the pulses using a first-time limited reversing threshold value during a first closing movement after power is turned on, and
the first-time limited reversing threshold value is set exceeding the physical quantity based on the pulses generated by the pulse generator when assuming that the window glass is sliding in the glass run.

7. The opening/closing control device according to claim 4, wherein
the opening/closing body is a window glass configured to slide in a window frame and reach the fully-closed position by sliding in a glass run of the window frame,
the control unit is configured to perform entrapment determinations based on the pulses if the pulses indicate that movement of the window glass has reduced speed when the electrostatic sensor does not detect entrapment,
the entrapment determinations based on the pulses include detecting entrapment when a physical quantity based on the pulses generated by the pulse generator becomes greater than or equal to a reversing threshold value,
the control unit is configured to use a first-time limited reversing threshold value to perform the entrapment determinations with the pulses if the pulses indicate that the movement of the opening/closing body has reduced speed when the electrostatic sensor detects capacitance that has increased within a range less than the threshold value during a first closing movement after power is turned on, and
the first-time limited reversing threshold value is set exceeding the physical quantity based on the pulses when assuming that the window glass is sliding in the glass run.
